(19) United States
(12) Patent Application Publication
(10) Pub. No.: US 2011/0254288 A1
(43) Pub. Date: Oct. 20, 2011

(54) CONTROL DEVICE COMPRISING A SWITCH, CONTROL DEVICE HOUSING, AND SWITCH FOR A CONTROL DEVICE

(75) Inventor: Didier Gaucher, Cretell Cedex (FR)

(73) Assignee: VALEO SECURITE HABITACLE, Creteil Cedex (FR)

(21) Appl. No.: 13/133,855

(22) PCT Filed: Dec. 15, 2009
(86) PCT No.: PCT/EP2009/067226

§ 371 Date: Jul. 8, 2011

(30) Foreign Application Priority Data
Dec. 18, 2008 (FR) 0807117

(51) Int. Cl. E05C 3/02; H01H 3/42

(52) U.S. Cl. 292/240; 200/573

(57) ABSTRACT

The invention relates to a control device for the door leaf a transport vehicle, comprising a housing (10, 100) and, in said housing, a switch (1, 201) provided with a plunger (6, 206), a cam (115, 15) mounted so as to rotate relative to the housing, and a mobile element (102, 202) capable of a transmission movement (T) as a result of an action applied by the cam when the latter rotates (R), said mobile element also being capable, through said transmission movement (T), of acting on the plunger so as to tilt the switch from a first electric state to a second electric state, characterised in that the mobile element has a shape moulded so as to protrude from the body (100, 204) of the device. More precisely, the mobile element (102, 202) includes a reception area (107, 207) capable of receiving a push force applied by the cam, a bending area (103, 203) capable of reversible deformation under the action of such a pushing force, and an action area (105, 205) capable of applying a pushing force on the plunger as a result of said deformation.

The present invention relates to a control device comprising a switch, for example to a lock or a handle for an opening leaf of a motor vehicle, notably for a door, tailgate, tailgate window or trunk. The invention also relates to a control device housing and to a switch for a control device.

Certain motor vehicle control devices comprise switches for electromagnetic functions of controlling locking, assisting with opening or closing, or even for producing information that is displayed on the instrument panel. Such a switch comprises a plunger and is actuated by a translational movement of the plunger, from the outside of the housing of the switch toward the inside thereof.

The switch may be controlled by a rotating cam that comes into contact with the outer end of the plunger. However, that is practicable only when the angle of attack with which the cam acts upon the plunger, measured with respect to the axis of translational movement of the plunger, is small (less than30°), because otherwise the cam applies transverse stress to the plunger, which is deviated in its translational movement. This stress is likely to be destructive toward the switch. Likewise, if the cam is driven with too high an angular velocity, the switch becomes damaged.

In order to avoid that, control devices are known in which the switch is provided with a control lever that pivots at the surface of the switch housing and that acts on the plunger at a small angle of attack. This control lever is an added component that may be screwed or clipped to the surface of the switch housing.

Such a solution is expensive because the switch has to be fitted with its lever which represents a cost because of the presence of an additional component that has to be purchased or produced separately. Switches fitted with such a lever are also more fragile because of the fact that there is an articulation for that lever.

It is an object of the present invention to address these problems.

For that reason the invention proposes, in the first aspect, a control device for an opening leaf of a transport vehicle, comprising a housing and, inside said housing, a switch equipped with a plunger, a cam mounted to rotate with respect to the housing, and a moving element capable of being driven with a transmission movement under the effect of an action exerted by the cam when the latter is driven with a rotation movement, said moving element also being able, through said transmission movement, to exert an action on the plunger so as to switch the switch from a first electrical state into a second electrical state, characterized in that the moving element is a molded shape projecting from a body of the device.

The device is therefore particularly economical and simple to manufacture, because the moving element is produced by molding, using a plastics processing mold.

The body can be any, preferably fixed, zone of the device. An action applied to the cam is transmitted to the switch.

For preference, the moving element comprises a receiving zone able to receive a thrust applied by the cam, a flexing zone able to undergo reversible deformation under the effect of such a thrust, and an action zone able to apply thrust to the plunger under the effect of said deformation.

Such a transmission mechanism is particularly reliable and effective and simple to implement, it easily being possible for a molded plastic shape to comprise a flexing zone able to undergo reversible deformation. The receiving and action zones may be two opposite faces one on each side of the moving element.

For preference, the moving element is a tab a first end of which comprises an elastic deformable zone connected to the body and a second end of which is free.

Such a transmission mechanism is particularly reliable and effective and also economical. The elastic deformable zone may be a flexing zone capable of deforming reversibly under the effect of the thrust of a cam. The action and receiving zones may be the opposite faces of the second end of the tab, the key point being that they need to be distant from the flexing zone so as to create a lever-arm effect.

Advantageously, the action of the moving element exerted on the plunger comprises a thrust applied at an angle smaller than 30° with respect to the axis of translational movement of the plunger. That makes it possible for the switch not to be damaged, because this thrust at less than 30° induces very little transverse stress on the plunger.

According to an advantageous feature, the body of the device, as a projection from which the moving element is molded, is itself made of molded plastic.

This makes the moving element easier to produce because it need merely be produced in the same molding operation as the body, the moving element constituting a protrusion from the molded plastic body.

In one simple embodiment, the device comprises a molded shape for positioning the switch in the housing, said moving element being molded with the shape for positioning the switch in the housing.

That simplifies the manufacture of the device, because one and the same molded shape is used both to position the switch (this may be part of the housing comprising a home for the switch, or part of the casing of the switch comprising bearing surfaces that serve to position the switch in a home within the housing) and to transmit the movement of the cam to the plunger.

In one embodiment, the device is a handle or, in another embodiment, a lock.

A second aspect of the invention proposes a motor vehicle opening leaf comprising a control device as stated.

This, depending on the embodiment, is a side door, a rear door, a tailgate or a trunk lid.

A third aspect of the invention proposes a housing for a control device as stated, the body of the device, as a projection from which the moving element is molded, forming all or part of the housing.

Using such a housing, a control device can be prepared using a switch that has no added lever that is positioned appropriately in the housing, which preferably comprises a space for the switch.

The plunger is positioned facing the moving element, which is then able to transmit a command from the rotating cam to the switch. Because the switch has no added lever, it is economical and the complete lock is likewise economical. In addition, the switch is robust as too is the lock.

It will be appreciated that the spaces for the switch and for the cam lie one on each side of the moving element, which is preferably a tab.

A fourth aspect of the invention proposes a switch that can be used in a control device as stated and characterized in that the body forms all or part of the casing of the switch.

Using such a switch, it is possible to prepare a control device without using an added lever.

The invention will now be described in detail in relation with the attached figures as described hereafter.

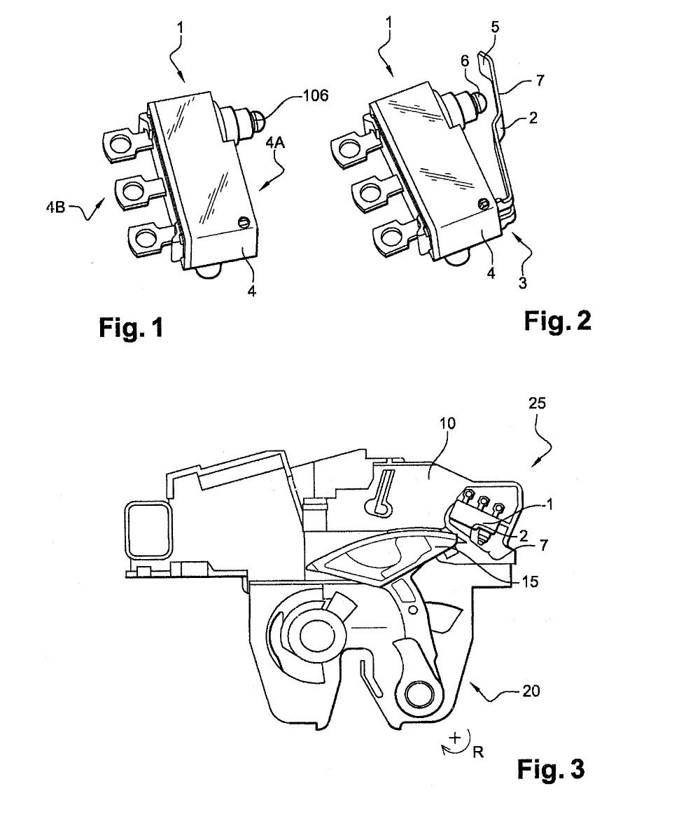

FIG. 1 is a view of a switch according to the prior art.

FIG. 2 is a view of the same switch, to which an additional lever has been fitted, this being an added component.

FIG. 3 is a view of a lock housing in which a switch according to FIG. 2 has been placed.

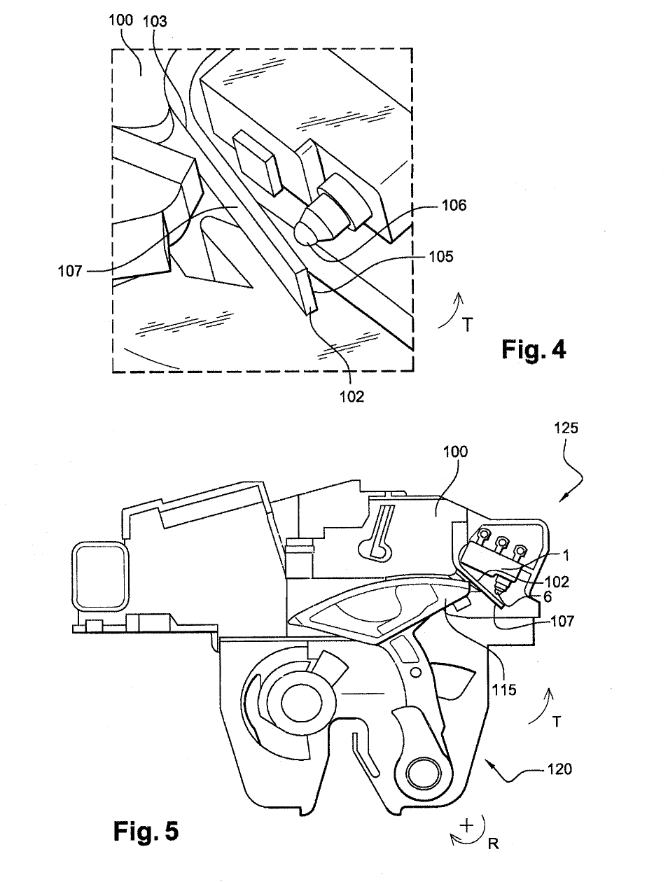

FIG. 4 is a detailed view of a lock housing according to a first embodiment of the invention, in which a switch and a cam have been placed.

FIG. 5 is a general arrangement of a lock housing according to the first embodiment of the invention, in which a switch and a cam have been placed.

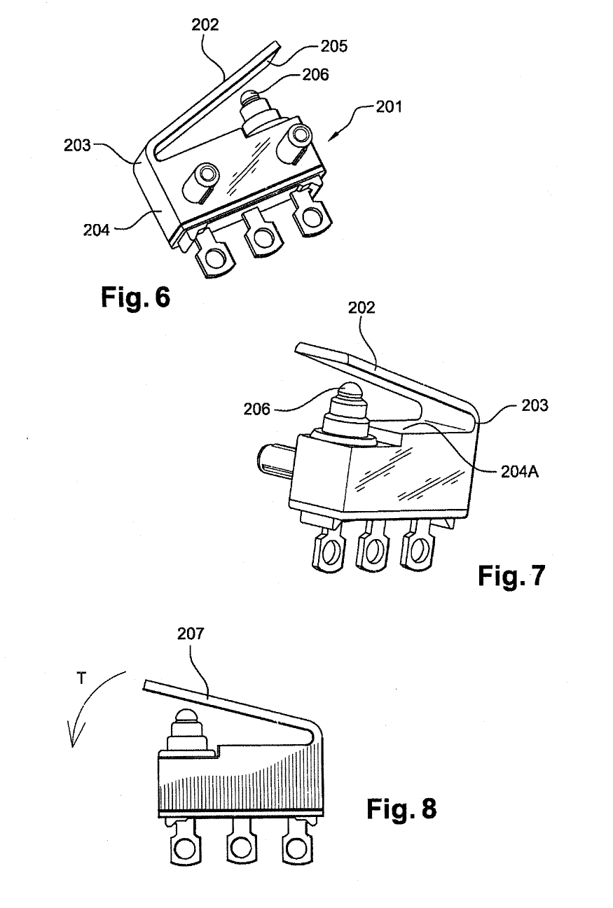

FIG. 6 is a view of a switch according to a second embodiment of the invention. FIGS. 7 and 8 are two further views of the same switch.

FIG. 1 depicts a switch 1 comprising a casing 4 the exterior shape of which is essentially that of a rectangular parallelepiped. The switch 1 has a plunger 6, mounted in translational movement with respect to the casing 4, perpendicularly and such that it projects with respect to a first face 4A of the casing 4, this first face 4A being opposite a second face 4B on which three electrical connections are mounted such that they project.

FIG. 2 depicts a switch 1 identical to the one above after there has been mounted on the switch 1, an added component that constitutes a control lever 2, i.e. a tab mounted substantially with the ability to rotate about an axis of pivoting 3 at the surface of the switch casing 4, and of which a part that is eccentric with respect to the axis of pivoting has its internal face 5 facing the outer end of the switch plunger 6. This added component is either screwed or clipped to the casing 4 of the switch 1, using known methods. The axis of pivoting 3 is parallel to the face 4A of the casing 4, slightly above the surface of the face 4A, at the opposite end to the plunger 6.

FIG. 3 depicts a motor vehicle lock housing 10 in which there is fitted a cam 15 and a switch 1 equipped with a control lever 2 as depicted in FIG. 2. The cam 15 is in a part of the lock housing intended to accept the cam, or cam space 20, while the switch is in a part of the housing intended to accept a switch, or switch space 25. The face 4A of the switch (which face is not visible because it is perpendicular to the plane of FIG. 3) faces the cam, the lever 2 being interposed between the cam and the casing 4.

The cam 15 is mounted such that it can rotate with respect to the housing 10 about an axis X (marked by a dot) perpendicular to the plane of the figure. The plane of the lever 2 is parallel to the axis of rotation X of the cam 15, the axis of pivoting of the lever 2 being parallel to the axis of rotation X, and the axis of translational movement of the plunger 6 being parallel to the plane of the figure.

During a rotational movement of the cam 15, an action zone of this cam comes into contact with the outer face of the control lever 2 in a contact zone that is eccentric with respect to the axis of pivoting of the lever.

By applying thrust, the cam 15 therefore causes the lever 2 to pivot about its axis of pivoting. Because of its configuration, the inner face of the eccentric part of the lever then comes into contact with the switch plunger at an angle of attack that is small with respect to the axis of translational movement of the plunger, and therefore without applying transverse stress to it.

The switch is therefore switched as a result of the rotational movement of the cam.

FIGS. 4 and 5 depict a first embodiment of the invention.

A motor vehicle lock housing 100 contains a cam 115 and a switch 101. The cam 115 and the switch 101 are not necessarily similar to the cam 15 and to the switch 1 introduced hereinabove. The housing 100 is made of molded plastic.

The cam 115 is in a part of the lock housing 100 intended to accept the cam, or cam space 120, while the switch 101 is in a part of the housing 100 intended to accept a switch, or switch space 125. The cam space 120 and the switch space 125 are not necessarily similar to the cam space 20 and to the switch space 25 introduced hereinabove. The switch space 125 is made of molded plastic.

The cam 115 is mounted so that it can rotate with respect to the housing 100 about an axis X perpendicular to the plane of the figure. The axis of translational movement of the plunger of the switch 101 is parallel to the plane of the figure. The face 4A of the switch (which face is not visible because it is perpendicular to the plane of FIG. 3) faces the cam, the lever 2 being interposed between the cam and the casing 4. During a rotational movement of the cam 115, an action zone thereof comes into contact with a face 107 of a plastic tab 102 that forms part of the lock housing 100 and is connected to the body thereof by one of its ends 103, by molding. The overall shape of the tab 102 is that of a rectangle, the end 103 forming one of the two short sides of the rectangle, and the tab having free edges along the other three sides of the rectangle. The end 103 is approximate to the edge face of the face 4A at the opposite end to the plunger 106 and is parallel to this edge face.

The thrust applied by the cam 115 to the tab 102 is applied at some distance from the end 103 that defines an axis of flexing (perpendicular to the plane of FIG. 5) of the tab, about which axis the tab may effect a pseudo-rotational movement.

The tab then undergoes a movement of flexing and of pivoting about its end 103. By thrusting, the cam 115 causes the tab 102 to pivot about its axis of flexing.

Because of its configuration, the second face of the tab, marked as the face 108, then comes into contact with the plunger 106 of the switch 101, which lies some distance from the end 103 of the tab.

Contact is made at an angle of attack that is small (less than 30°) with respect to the axis of translational movement of the plunger, and therefore without applying transverse stress thereto.

The switch 101 is then switched from a first electrical state to a second electrical state because of the rotational movement of the cam.

Once the cam has ceased to apply thrust to the tab 102, either because it has continued to rotate and its action portion has passed beyond the tab, or because it has effected a rotational movement in the opposite direction, the tab reverts to its initial position because of the elastic nature of the end 103 of the tab 102.

In a second embodiment, a housing 10 like the one depicted in FIG. 3 is used in combination with a switch 201 like the one depicted in FIGS. 6 to 8.

This switch comprises a casing 204 of substantially rectangular parallelepiped shape, with a plunger 206 projecting from a face 204A opposite to a face on which three electrical connections are positioned. The casing 204 is essentially made of molded plastic. It notably serves, on account of its parallelepipedal shape, to position the switch in a switch space.

Molded, as a continuation of the molded plastic of the casing 204, at the edge face of the face 4A opposite to the plunger 206 is a control lever 202, the shape of which is that of a flat rectangular plastic tab.

One of the short sides of the rectangle constitutes the junction between the tab and the casing 204, at the edge face of the face 4A opposite to the plunger 206 and constitutes an axis of pivoting or of flexing 203 for the tab. One of the faces of the tab, known as the inner face 205, faces the plunger 206.

A thrust applied to the second face of the tab, known as the outer face 207, at a position distant from the axis 203 is able to cause a transmission movement T that makes the inner face 205 press against the plunger 206 and toggle the switch from a first electrical position into a second electrical position. This thrust may be applied by the cam 15 depicted in FIG. 3, once the switch 201 has been positioned in the switch space 25.

It must be emphasized that, in one embodiment, the cams 15 and 115 correspond to a means of locking the motor vehicle from the outside. In a second motor vehicle, they correspond to a means of locking the motor vehicle from the inside. In a third embodiment, they correspond to a means of locking both from the inside and from the outside. In such embodiments, they are driven by manual action on the part of a user, either directly or indirectly, using a handle or a key, and in other embodiments by a motor operated by an electrical control, possibly triggered by remote control or by radio control.

In various embodiments, the lock is installed on a front side door, rear door or on a trunk or tailgate of a motor vehicle.

The invention is not restricted to the embodiment described but also includes any alternatives within the competence of a person skilled in the art.

1. A control device for an opening leaf of a transport vehicle, comprising:
a housing;
a switch inside the housing equipped with a plunger;
a cam mounted to rotate with respect to the housing; and
a moving element capable of being driven with a transmission movement under effect of an action exerted by the cam when the latter is driven with a rotation movement, said moving element also being able, through said transmission movement, to exert an action on the plunger so as to switch the switch from a first electrical state into a second electrical state,
wherein the moving element is a molded shape projecting from a body of the control device.

2. The control device as claimed in claim 1, wherein the moving element comprises:
a receiving zone able to receive a thrust applied by the cam,
a flexing zone able to undergo reversible deformation under effect of the thrust applied by the cam, and
an action zone able to apply thrust to the plunger under effect of said reversible deformation.

3. The control device as claimed in claim 1, wherein the moving element is a tab, a first end of which comprises an elastic deformable zone connected to the body and a second end of which is free.

4. The control device as claimed in claim 1, wherein the action of the moving element exerted on the plunger comprises a thrust applied at an angle smaller than 30° with respect to an axis of translational movement of the plunger.

5. The control device as claimed in claim 1, wherein said body is made of molded plastic.

6. The control device as claimed in claim 1, further comprising comprises a molded shape for positioning the switch inside the housing, said moving element being molded with said molded shape for positioning the switch inside the housing.

7. The control device as claimed in claim 1, wherein the control device is a lock.

8. The control device as claimed in claim 1, it wherein the control device is a handle.

9. A motor vehicle opening leaf comprising a control device, the control device comprising:
a housing;
a switch inside the housing equipped with a plunger;
a cam mounted to rotate with respect to the housing; and
a moving element capable of being driven with a transmission movement under effect of an action exerted by the cam when the latter is driven with a rotation movement, said moving element also being able, through said transmission movement, to exert an action on the plunger so as to switch the switch from a first electrical state into a second electrical state,
wherein the moving element is a molded shape projecting from a body of the control device.

10. The opening leaf as claimed in claim 9, it wherein the opening leaf is a side door or a rear door.

11. The opening leaf as claimed in claim 9, wherein the opening leaf is a tailgate or a trunk lid.

12. A housing of a control device as claimed in claim 1, wherein the body of the control device forms all or part of the housing.

13. A switch in a control device as claimed in claim 1, wherein the body of the control device forms all or part of a casing of the switch.
